(19) United States
(12) Patent Application Publication
(10) Pub. No.: US 2009/0181567 A1
(43) Pub. Date: Jul. 16, 2009

(54) SEALED CONNECTOR

(75) Inventors: Darren J. STOCKTON, Chardon, OH (US); Rich LESIACSEK, Willoughby Hills, OH (US)

Correspondence Address: HAHN LOESER & PARKS, LLP, One GOJO Plaza, Suite 300, AKRON, OH, 44311-1076, US

(73) Assignee: LINCOLN GLOBAL, INC., City of Industry, CA (US)

(21) Appl. No.: 12/013,621

(22) Filed: Jan. 14, 2008

(51) Int. Cl. H01R 13/52

(52) U.S. Cl. 439/271

(57) ABSTRACT

A connector housing includes one or more cavities for receiving corresponding conductors used to electrically communicate one or more circuits. The connector housing includes a seal on a first surface that prevents the passage of contaminants or other substances from the region between the cavities and the conductors. The seal may include recesses positioned to align with the one or more cavities of the connector housing. The conductors may be connected to the connector housing by pushing the conductors through the seal where after the seal automatically closes around the protruding conductors.

### TECHNICAL FIELD

The present invention pertains to connector seals, and more particularly, to seals that prevent contamination and/or other substances from entering an electrical connector from around the conductors.

### BACKGROUND OF THE INVENTION

Electric and electronic circuits are prevalent in today's society. They can be found in all types of industrial equipment as well as innumerable commercial products. The size, versatility and programmability of circuits allow it to be used in seemingly endless applications. Accordingly, in some circumstances, electronic circuits find their way into harsh environments characterized by dirt, dust, moisture, salt and other corrosive materials that can detrimentally impact the function of the circuit.

Circuits are typically grouped together on a circuit board. In many instances, it is necessary for the circuits of one circuit board to communicate with the circuits of another circuit board; usually accomplished through the use of connectors. Connectors include a housing, constructed from a dielectric material, which mounts to a complementary connecting device; the area in between comprising the connector interface. The connector portions usually include mating conductive terminals for establishing the electrical connection between circuits.

Some connectors seal the interface of the electrical connector assembly to protect the interior components, i.e. the conductive terminals from contamination. However, the state of the art does not address the concern of water and other contamination that penetrates the connectors from the back side of the connector where the conductors enter the connector housing.

It would be useful to incorporate a seal that protects the rearward side of the connector from unwanted substances. What is needed is a seal that functions with any quantity of conductors to prevent water and other contaminants from entering the connector. The embodiments of the subject invention obviate aforementioned problems.

### BRIEF SUMMARY

The embodiments of the present invention pertain to an electrical connector including a connector housing having a first side adapted to couple with an associated matching connector housing for establishing an electrical connection and a second side having one or more apertures configured to receive at least a first associated conductor, and means for substantially preventing substances from entering the connector housing from the second side.

In one aspect of the embodiments of the subject invention said means for substantially preventing substances from entering the connector housing comprises a contiguously formed barrier juxtaposed to the connector housing.

In another aspect of the embodiments of the subject invention, the barrier encircles the girth of the at least a first associated conductor for substantially preventing substances from entering the one or more apertures.

In yet another aspect of the embodiments of the subject invention, the barrier is generally planar having a characteristic thickness and one or more recesses fashioned in a planar face of the barrier, and wherein the one or more recesses are respectively positioned corresponding to the one or more apertures. When the at least a first associated conductor passes through the one or more recesses, the barrier may re-close around the conductor thereby substantially preventing substances from passing between the electrical conductor and the barrier.

In even another aspect of the embodiments of the subject invention, the barrier is constructed from a pliable material, which may be silicon.

In still another aspect of the embodiments of the subject invention, said means for substantially preventing substances from entering the connector housing substantially spans the entire second side of the connector housing.

In still yet another aspect of the embodiments of the subject invention, said means for substantially preventing substances from entering the connector housing spans a surface area defined by the one or more apertures.

In another aspect of the embodiments of the subject invention, said means for substantially preventing substances from entering the connector housing is configured to overlap one or more faces of the connector housing.

In another embodiment of the subject invention, a method of sealing the area between an electrical connector and one or more conductors includes the steps of providing a connector housing having one or more cavities for receiving at least a first electrical conductor, covering the one or more cavities with a seal, inserting the at least a first electrical conductor through the seal, and securing the electrical conductor to the connector housing.

One aspect of the embodiments of the subject invention includes the step of affixing the seal with respect to the connector housing and providing a generally planar sheet of material spanning a surface area of the connector housing defined by the one or more cavities.

Another embodiment of the subject invention includes a seal for an electrical connector housing having one or more cavities for receiving one or more electrical conductors comprising a generally planar section of material having one or more recesses fashioned in a first side of the generally planar section of material, wherein the one or more recesses are oriented respective to the spacing of the one or more cavities.

In one aspect of the embodiments of the subject invention the seal overlaps the area defined by the one or more cavities.

### BRIEF DESCRIPTION OF THE DRAWINGS

FIG. 1 is a perspective view of a connector housing and corresponding conductors according to the embodiments of the subject invention.

FIG. 2 is a perspective view of an electrical connector connected to a circuit board according to the embodiments of the subject invention.

FIG. 2a is a perspective view of an electrical connector housing connected to a matching electrical connector housing according to the embodiments of the subject invention.

FIG. 3 is a perspective view of a connector housing seal according to the embodiments of the subject invention.

FIG. 4 is a sectional view of a connector housing seal according to the embodiments of the subject invention.

FIG. 4a is a perspective view of a connector housing seal according to the embodiments of the subject invention.

### DETAILED DESCRIPTION OF THE INVENTION

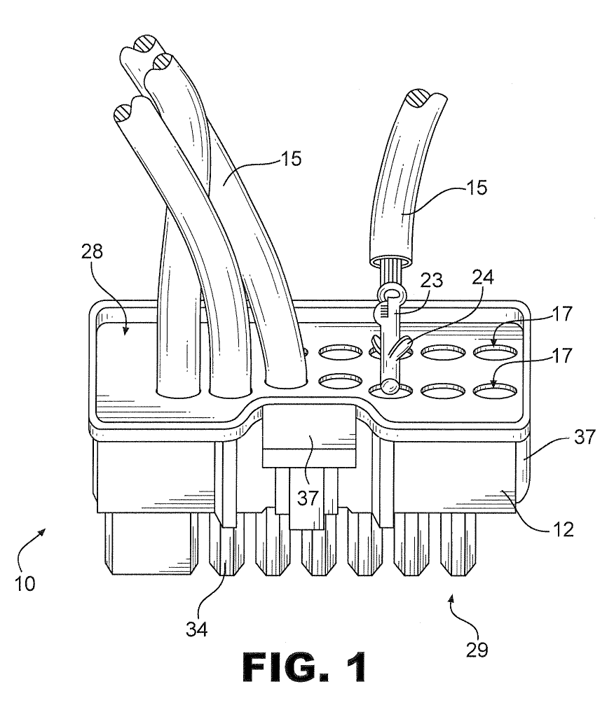

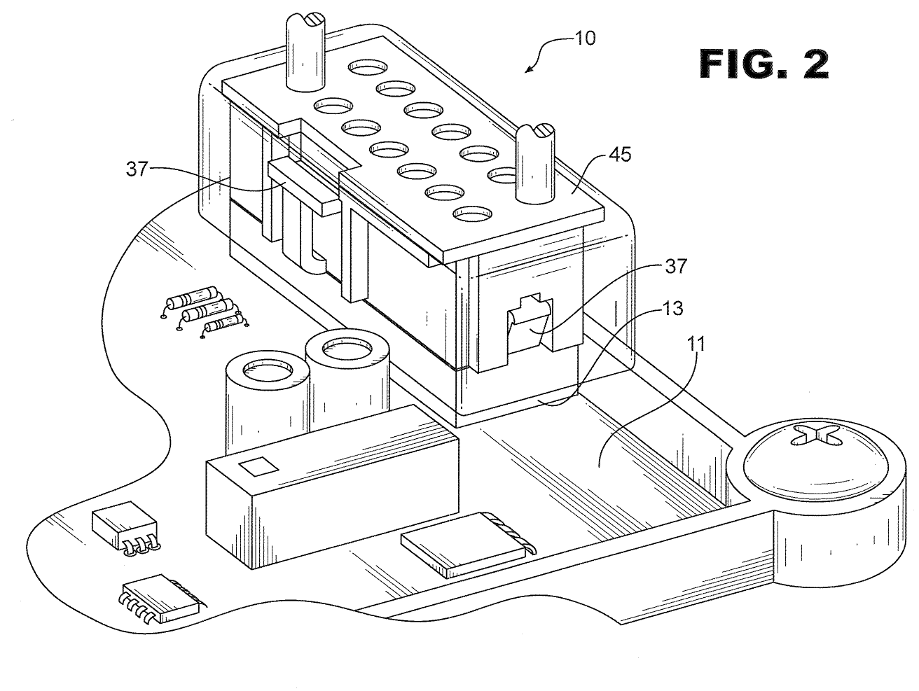

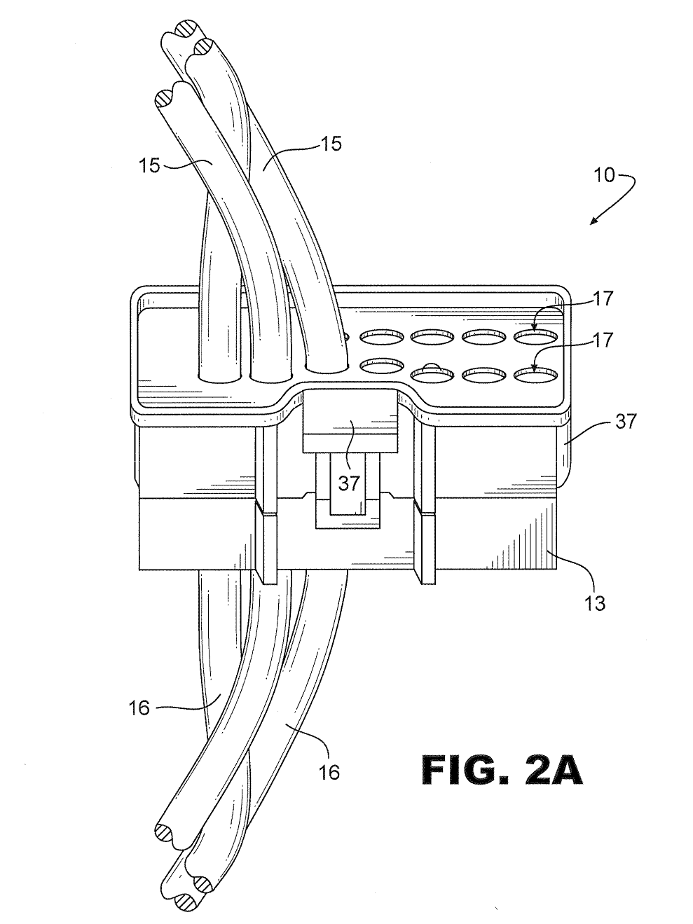

Referring now to the drawings wherein the showings are for purposes of illustrating embodiments of the invention only and not for purposes of limiting the same, FIG. 1 shows a an electrical connector depicted generally at 10. The electrical connector 10 may be configured to connect to a circuit board as shown in FIG. 2. Alternatively, the electrical connector 10 may connect to another matching or corresponding connector portion, shown in FIG. 2a. However, persons of ordinary skill in the art will understand the application of the embodiments of the subject invention to any type of electrical connector 10. The electrical connector 10, also termed connector 10, may include a connector housing 12 configured to receive one or more electrical conductors 15 for establishing a connection between circuits in a manner well known in the art. Such articles may be utilized for example in a welding power supply or in an industrial controller but may be used in any electrical circuit. The connector housing 12 may be constructed as a generally rigid or semi-rigid article fashioned with cavities 17 or apertures 17 on at least one side or first face. The cavities 17 may have a configuration that securely holds the electrical conductors 15 in place during use. In one embodiment, terminals pins 23 may be used that, at one end, crimp around the electrical conductor 15 thereby creating an electrical connection between the electrical conductor 15 and the terminal pin 23. The terminal pin 23 may then inserted into the connector housing 12. In an exemplary manner, the terminal pin 23 may include barbs 24 that extend outward with respect to a longitudinal axis of the terminal pin 23 and may engage ridges, not shown, within the connector housing 12 that prevent the terminal pin 23 from releasing after it has been inserted. In other types of connectors 10 the terminal pins 23 may integrally fashioned within the connector housing 12, may be pre-inserted or may not include terminal pins at all. Accordingly, the connector housing 12 functions as a support structure for securely receiving one or more electrical conductors 15.

With reference to FIGS. 1 and 2, side 28 of the connector housing 12 includes a plurality of cavities 17, as mentioned above. The plurality of cavities 17 may correspond to individual conductors 15 used to connect electrical circuits. It is noted here that not all of the cavities 17 may be utilized, i.e. connected to an electrical conductor 15, in a given application. Rather, any number of cavities 17 may be used as is appropriate for a given application. The distal side 29 of the connector housing 12 may be configured to receive a corresponding or matching connector 13, which may be mounted directly to a circuit board 11 or which may receive its own terminal pins and corresponding electrical conductors 16, as shown in FIG. 2a. In one embodiment, side 29 of the connector housing 12 may include a series of protruding members 34 corresponding to each of the plurality of cavities 17 respectively. The protruding members 34, herein referred to as the male connector portion, may be positioned to match and receive corresponding recesses in the matching connector 13. When fit together, the electrical conductors from each connector housing make contact thereby establishing electrical communication between individual circuits. It is noted here that the shape of the mating portions ensure proper alignment of the respective connector housings and correspondingly ensure proper connection between circuits. The connector 10 may further include latching members 37, which may be used to lock the connector housings 12, 13 together. The latching members 37 may be integrally fashioned into each of the respective connector housings 12, 13. However any means may be used to hold the connector housings 12, 13 together.

The connector 10, and more specifically the connector housing 12, may be constructed from a dielectric material for isolating the electrical signals from individual circuits being communicated through the connector 10. In one embodiment, the connector housing 12 may be fashioned as a unitary article. However, other embodiments are contemplated where the connector housing 12 may be comprised of one or more assembled components. Any of a number of processes may be used to manufacture the connector housing 12 including but not limited to injection molding. As such, the connector housing 12 may be constructed from a thermoplastic material. In fact, the connector housing 12 may be constructed from any dielectric material that is appropriate for use with the embodiments of the subject invention. It is to be construed that the scope of coverage relating to the embodiments of the subject invention is not limited to the specific configuration and/or material used to construct the connector 10.

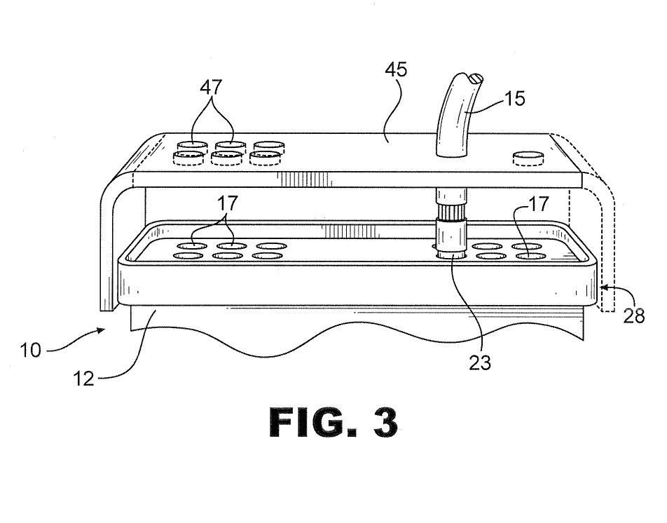

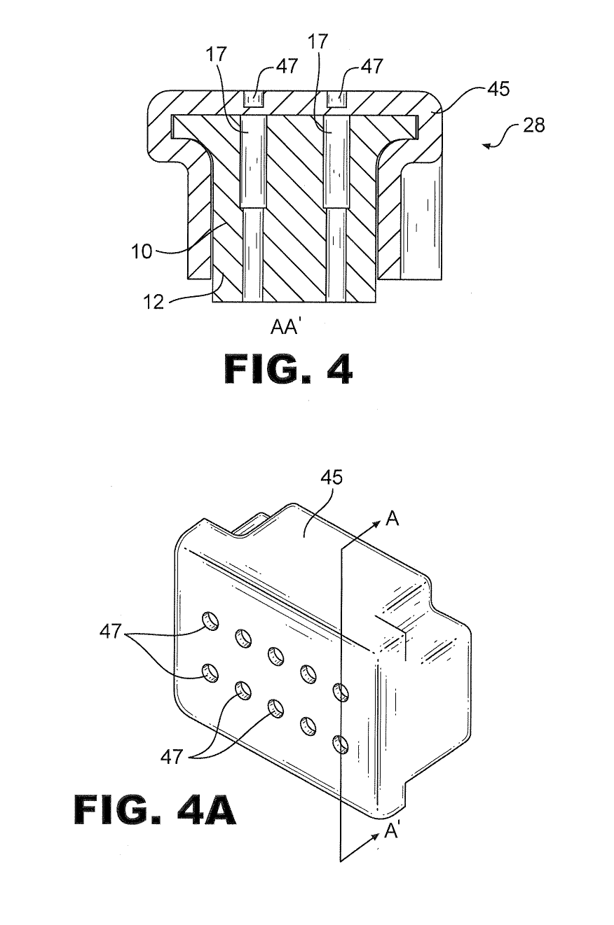

With continued reference to FIG. 2 and now also to FIGS. 3 and 4a, clearance between conductors 15 and the inner circumference of the cavities 17 may allow for the passage of various substances, which may be undesirable, into the connector 10. Accordingly, a seal 45 may be incorporated to prevent substances from entering the connector 10 via the cavities 17. The seal 45 may prevent different types of substances from entering the connector 10 including but not limited to: fluid substances, dust and/or other particulate matter. In one embodiment, the seal 45 may span at least a portion of side 28 of the connector 10. More specifically, the seal 45 may cover a contiguous surface area of side 28 defined by the number and/or positioning of the cavities 17. It follows that the presence of the seal 45 therefore comprises a barrier that substantially prevents substances from entering the connector 10 through the cavities 17. In one embodiment, the seal 45 may be a unitary article, contiguously formed from a single piece of material. However, it is contemplated that the seal 45 may be constructed from one or more individual portions. Additionally, the seal 45 may be shaped to match the configuration of a particular connector 10. This may include the length, width and height, as well as any contour, of the connector 10. FIGS. 4 and 4a illustrate one embodiment where the seal 45 is form fitting with respect to the shape of the connector 10. In this manner, the seal 45 may cover all or most of the outer surface area of the connector 10. It will be appreciated that the snug fit significantly reduces the amount of debris entering the connector 10. However, persons of ordinary skill in the art will readily understand the application of the embodiments of the subject invention without regard to a particular configuration of the seal 45 and/or the connector members 10, 13.

In one embodiment, the conductors 15 may be received by the connector 10 after penetrating the seal 45. That is to say that the conductors 15 may be inserted through the seal 45 prior to insertion into the connector 10. The seal 45 may be constructed from a pliable material capable of closing around the conductor 15 extending therethrough. This forms an effective barrier for substantially preventing substances from leaking through. The seal 45 may be comprised of a resiliently deformable material. By resiliently deformable it is meant that the material may have memory wherein when the material is stretched or contorted, it has a general tendency to return to its original shape. As such when the conductor is inserted through the seal 45, the material comprising the seal 45 will encircle the outer circumference of the conductor 15. The seal material may be sufficiently pliable so as to automatically conform to a range diameters and configurations of conductors 15 without affecting its sealing capabilities. In this manner, the seal 45 may be constructed from a polymer material, which may be silicon. However, any material may be used having any degree elasticity as is appropriate for use with the embodiments of the subject invention.

With continued reference to FIGS. 2 and 3, the seal 45 may be constructed having one or more recesses 47 fashioned at various locations. The wall thickness of the seal material at the one more recesses 47 is therefore thinner than the wall thickness of the remaining seal material. In an exemplary manner, the wall thickness of the one or more recesses 47 may extend from 0.010 inch to 0.050 inch. However, any wall thickness of the one or more recesses 47 may be chosen with sound engineering judgment. It is also noted here that any thickness of the remaining seal material may be chosen as is appropriate for use with the embodiments of the subject invention. The position of the one or more recesses 47 may correspond to the position of the cavities 17 formed in the connector housing 12. In this manner, when inserted through the seal 45, the conductors 15 may be aligned with the cavities 17.

In operation, the seal 45 may be juxtaposed to the first side 28 of the connector 10 prior to installing the conductors 15 into the connector housing 12. In one embodiment, the seal 45 may overlap the edges of the connector housing 12. When assembled, the overlapping edges may cover the latching members and the sides of the connector housing 12. Alternatively, the seal 45 may have surface area similar to that of the first side 28 of the connector housing 12 and may be held in place by way of an adhesive, which may be a tacky, re-sealable adhesive such as that made by the 3M Corporation. In yet another embodiment, the seal 45 may integrally fashioned with the connector housing 12. Still, any manner of holding the seal 45 in place with respect to the connector housing 12 may be chosen as is appropriate for use with the embodiments of the subject invention. The conductors 15 may then be pushed through the recesses 47 respective of their intended position within the circuits as communicated by the connector 10.

The invention has been described herein with reference to the disclosed embodiments. Obviously, modifications and alterations will occur to others upon a reading and understanding of this specification. It is intended to include all such modifications and alterations insofar as they come within the scope of the appended claims or the equivalence thereof.

1. An electrical connector, comprising:
a connector housing having a first side adapted to couple with an associated complementary connector for establishing an electrical connection and a second side having one or more apertures configured to receive at least a first associated conductor; and,
means for preventing substances from entering the connector housing from the second side,
said means including a body having one or more recesses adapted to receive the at least a first associated conductor; and,
wherein the one or more recesses are sealed by a breakable cover.

2. (canceled)

3. The electrical connector as defined in claim 1, wherein the at least a first associated conductor defines a circumference: and,
wherein the body is elastically deformable to encircle the circumference of the at least a first associated conductor for preventing substances from entering the one or more apertures.

4. The electrical connector as defined in claim 1, wherein the body is contiguously formed and generally planar having one or more sealed recesses fashioned in a planar face of the contiguously formed and generally planar body, and
wherein the one or more sealed recesses are respectively positioned corresponding to the one or more apertures.

5. The electrical connector as defined in claim 3, wherein when the at least a first associated conductor passes through the breakable cover at least a portion of the body defining the one or more sealed recesses encloses the circumference of the at least a first associated conductor thereby substantially preventing substances from entering the connector housing.

6. The electrical connector as defined in claim 4, wherein the contiguously formed and generally planar body is constructed from a pliable material.

7. The electrical connector as defined in claim 4, wherein the contiguously formed and generally planar body is comprised of silicon.

8. The electrical connector as defined in claim 4, wherein said means for preventing substances from entering the connector housing substantially spans the second side of the connector housing.

9. The electrical connector as defined in claim 4, wherein said means for preventing substances from entering the connector housing spans a surface area defined by the one or more apertures.

10. The electrical connector as defined in claim 1, wherein said means for preventing substances from entering the connector housing is configured to overlap multiple sides of the connector housing.

11. The electrical connector as defined in claim 1, wherein said means for preventing substances from entering the connector housing is fixedly attached with respect to the connector housing.

12. The electrical connector as defined in claim 1, wherein said means for preventing substances from entering the connector housing is integrally formed with the connector housing.

13. A method of sealing the area between an electrical connector and one or more conductors, comprising the steps of:
providing a connector housing having one or more apertures for receiving at least a first electrical conductor;
covering the one or more apertures with a seal having an enclosed conductor receiving portion defined by one or more recesses covered by a breakable membrane;
inserting the at least a first electrical conductor through the breakable membrane; and,
securing the at least a first electrical conductor to the connector housing.

14. The method as defined in claim 13, further comprising the step of:
affixing the seal with respect to the connector housing.

15. The method as defined in claim 13,
wherein the seal comprises a generally planar sheet of material spanning at least a surface area of the connector housing defined by the one or more apertures.

16. The method as defined in claim 15, further comprising the step of:
fashioning a generally planar sheet of material having one or more covered recesses wherein the position of the one or more covered recesses in the generally planar sheet of material corresponds to the position of the one or more apertures respectively.

17. The method as defined in claim 15, wherein the generally planar sheet of material is constructed from a pliable material that reseals the at least a first electrical conductor when the at least a first electrical conductor is inserted through the breakable membrane.

18. A seal for an electrical connector housing receiving one or more electrical conductors, comprising:
a generally planar seal body having one or more recesses fashioned in a first side of the generally planar seal body for receiving one or more associated electrical conductors, wherein each of the one or more recesses is enclosed by a breakable cover; and
wherein the seal body is adapted to close around one or more associated electrical conductors inserted through the breakable cover.

19. The seal as defined in claim 18, wherein the seal body is monolithic and overlaps an area defined by the one or more cavities.

20. (canceled)

21. The seal as defined in claim 18, wherein the breakable cover has a wall thickness that is substantially thinner than the wall thickness of the generally planar seal body.

22. The seal as defined in claim 21, wherein the wall thickness of the breakable cover is in the range substantially between 0.010 inch and 0.050 inch.

23. The seal as defined in claim 13, wherein the step of inserting the at least a first electrical conductor through the breakable membrane, comprises the step of:
inserting the at least a first electrical conductor into the one or more recesses, wherein less than all of the one or more recesses are filled with an electrical conductor.
